(19) United States
(12) Patent Application Publication
(10) Pub. No.: US 2010/0046348 A1
(43) Pub. Date: Feb. 25, 2010

(54) OPTICAL MODULE, OPTICAL COMMUNICATION DEVICE USING THE SAME AND REFLECTIVE OPTICAL PATH SETTING METHOD

(76) Inventor: TAKAMI IWAFUJI, Tokyo (JP)

Correspondence Address: Mr. Jackson Chen, 6535 N. STATE HWY 161, IRVING, TX, 75039, US

(21) Appl. No.: 12/536,764

(22) Filed: Aug. 6, 2009

(30) Foreign Application Priority Data
Aug. 19, 2008 (JP) 210616/2008

(51) Int. Cl. G11B 7/00

(52) U.S. Cl. 369/112.23; 369/112.01; G9B/7

(57) ABSTRACT

An optical module having a laser element which emits a laser beam, include an optical path setting material which reflects a part of the laser beam in a predetermined direction; and a shield element which blocks the laser beam that is reflected by the optical path setting material.

This application is based upon and claims the benefit of priority from Japanese Patent Application No. 2008-210616, filed on Aug. 19, 2008, the disclosure of which is incorporated herein in its entirety by reference,

### TECHNICAL FIELD

The present invention relates to an optical module with a laser element that emits a laser beam, and optical communication device using the module and reflective optical path setting method.

### BACKGROUND ART

In recent years, in a technical field of optical communication, improvement of a transmission capacity is strongly required. In order to meet the requirement, technical development for a highly-functional, small-sized and low cost optical module for optical communication proceeds.

The optical module includes the laser element that emits the laser beam, a package that includes the laser element, and a transparent glass installed in the package. Further, an optical fiber is arranged on an outside of the package. The laser beam passes through the transparent glass and enters the optical fiber.

In addition, a monitoring element to monitor power of the laser beam that is emitted from the laser element is included in the package. Monitored results of the monitoring element are used to control the power of the laser beam.

Moreover, the optical module includes a lens such as a collimator lens, a condenser lens, or the like so that the laser beam may efficiently enter the optical fiber.

An incidence surface and an output surface for transparent glasses, various lenses, or the like are defined as follows. When the laser beam emitted from the laser element passes through the transparent glass or various lenses and enters an object such as the optical fiber, the incidence surface corresponds to a surface where the laser beam enters the transparent glass, a lens, or the like, and the output surface corresponds to a surface where the beam is emitted from the transparent glass, the lens, or the like.

In such a configuration, the laser beam emitted from the laser element may be reflected at the incidence surface and the output surface of the transparent glass and/or the condenser lens, and the reflected laser beam may enter the laser element or the monitoring element. When a reflected laser beam (hereinafter, reflected light) enters the laser element, the laser element suffers damages and output characteristics thereof become unstable. Further, when the reflected light enters the monitoring element, it is difficult to correctly monitor the power of the laser beam.

Therefore, Japanese Patent Application Laid-Open No. 1992-355705 and Japanese Patent Application Laid-Open No. 1997-178986 propose an optical module where a transparent glass is inclined to an optical path of a laser beam. FIG. 11 is a longitudinal sectional view of the optical module disclosed in Japanese Patent Application Laid-open No. 1992-355705.

An incidence surface 101a of the transparent glass 101 that is installed in the package 100 is inclined in a direction of a ceiling 106 of the package 100, which is a direction toward the upper side in FIG. 11. Therefore, even if a part of the laser beam, that enters the transparent glass 101 after passing through the collimator lens 104, is reflected by the incidence surface 101a and/or by an output surface 101b of the transparent glass 101, an optical path of a reflected light P2 becomes different from a path of a laser beam P1. Accordingly, it is difficult for the reflected light P2 to enter the laser element 103. Additionally, the monitoring element 105 receives the laser beam P11 emitted from the laser element 103.

Japanese Patent Application Laid-Open No. 1997-258071 proposes an optical module in which a fiat surface of a spherical planoconvex lens, which works as a condenser lens, is inclined to an optical path of a laser beam. FIG. 12A is a horizontal sectional view of the optical module disclosed by Japanese Patent Application Laid-Open No. 1997-258071. FIG. 12A is a horizontal sectional view of a ferrule holder 117 and an optical fiber 116 in which the spherical planoconvex lens 110 is inclined to a plane vertical to the optical path of a laser beam P3. FIG. 12C is a horizontal sectional view of a modified example of the ferrule holder 117 and the spherical planoconvex lens 110 in which the flat surface 111a of the spherical planoconvex lens 110 is inclined to the optical path of the laser beam P3.

As shown in FIG. 12A, the cylindrical ferrule holder 117 that holds the optical fiber 116 is attached to an outside of the package 115. The ferrule holder 117 includes the spherical planoconvex lens 110 with the flat surface 111 therein. The laser beam P3 from the laser element 118 is changed into a parallel beam by a collimator lens 120 and enters the spherical planoconvex lens 110. As shown in FIG. 12C, spherical convex lens 110a is fixed in parallel with the laser beam P3 in the ferrule holder 117a. The flat surface 111a of the output surface is inclined to a plane vertical to the optical axis.

Since the flat surfaces 111 and 111a of the spherical planoconvex lens 110 and 110a are inclined to the optical path of the laser beam P3 as shown in FIG. 12A and FIG. 12c, the optical path of the laser beam P4 that is reflected from the flat surfaces 111 and 111a is different from the optical path of the laser beam P3.

As the result, the amount of the reflected light that enters the laser element 118 decreases. In FIG. 12A, a reference numeral 119 indicates a monitoring element that receives the laser beam P44 emitted from the laser element 118.

In the optical module shown in FIG. 11 and FIGS. 12A to 12C, though the reflected lights P2 and P4 are prevented from entering the laser element 103, 118, it is not assumed that the reflected light enters a material that may affect output characteristics of the laser beam such as output power, wavelength, and the like (a material other than the laser element). If the reflected light enters such materials, the output characteristics of the optical module become unstable.

### SUMMARY

An exemplary object of the invention is to provide an optical module including a laser element that emits a laser beam, and optical communication device using the module and reflective optical path setting method.

An optical module having a laser element which emits a laser beam, include an optical path setting material which reflects the laser beam in a predetermined direction; and a shield element which blocks the laser beam that is reflected by the optical path setting material.

An optical module having a laser beam emitting means which emits a laser beam including an optical path setting means for reflecting the laser beam in a predetermined direction; and a shield means for blocking the laser beam reflected by the optical path setting means.

An optical communication device including a laser element which emits a laser beam; an optical path setting material which reflects the laser beam in a predetermined direction; an optical module including a shield element which blocks the laser beam reflected from the optical path setting material; a driving circuit which drives the optical module; and an optical fiber which the laser beam from the optical module enters.

A reflective optical path setting method, including reflecting a laser beam emitted from a laser element in a predetermined direction; and blocking the laser beam reflected by the reflective procedure.

### BRIEF DESCRIPTION OF THE DRAWINGS

Exemplary features and advantages of the present invention will become apparent from the following detailed description when taken with the accompanying drawings in which:

FIG. 1 is a side view of an optical module according to a first exemplary embodiment of the present invention;

FIG. 2 is a longitudinal sectional view of an optical module according to a second exemplary embodiment of the present invention;

FIG. 3 is a side view of the optical module having an airtight sealing glass that is inclined upwardly according to the second exemplary embodiment;

FIG. 4 is a side view of the optical module having the airtight sealing glass that is inclined downwardly according to the second exemplary embodiment;

FIG. 5 is a horizontal sectional view of an optical module according to a third, exemplary embodiment of the present invention;

FIG. 6 is a longitudinal sectional view of an optical module according to a fourth exemplary embodiment of the present invention;

FIG. 7 is a longitudinal sectional view of an optical module according to a fifth exemplary embodiment of the present invention;

FIG. 8A is a fragmentary longitudinal cross-section of an optical module where an output surface of a condenser lens is inclined counterclockwise according to the fifth exemplary embodiment;

FIG. 8B is a fragmentary longitudinal cross-section of an optical module where the output surface of the condenser lens is inclined clockwise according to the fifth exemplary embodiment;

FIG. 9 is a flowchart of a reflective optical path setting method according to a sixth exemplary embodiment of the present invention;

FIG. 10 is a fragmentary longitudinal cross-section of an optical communication device according to a seventh exemplary embodiment of the present invention;

FIG. 11 is a longitudinal cross-section of the optical module according to related art;

FIG. 12A is a horizontal cross-section of the optical module of other configuration according to related art;

FIG. 12B is a horizontal cross-section of a ferrule holder and an optical fiber in which a spherical planoconvex lens is inclined with respect to an optical path of a laser beam according to related art; and

FIG. 12C is a horizontal cross-section of the ferrule holder and the spherical planoconvex lens in which a flat surface of the spherical planoconvex lens is inclined with respect to the optical path of the laser beam according to related art.

### EXEMPLARY EMBODIMENT

Exemplary embodiments of the present invention will now foe described in detail in accordance with the accompanying drawings.

### 1. First Exemplary Embodiment

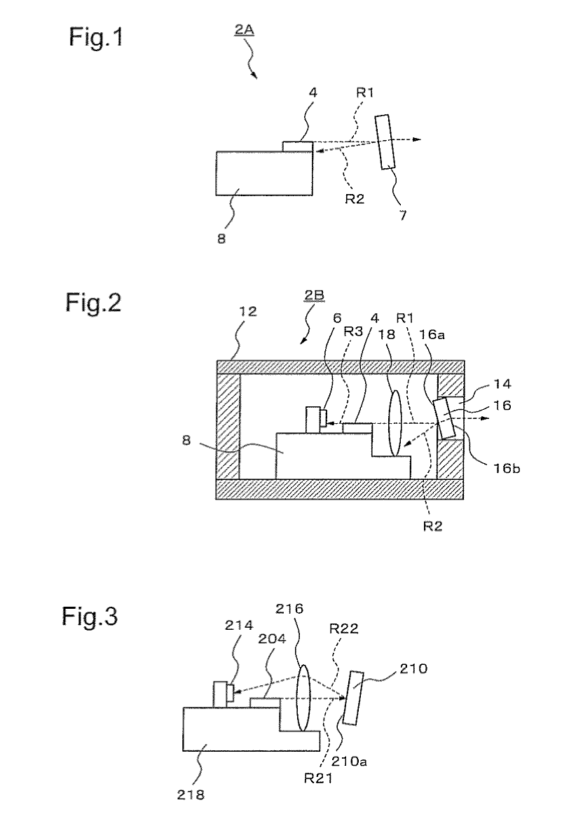

A first exemplary embodiment of the present invention is described below. FIG. 1 is a side view of an optical module according to the first exemplary embodiment. The optical module 2A includes a laser element 4 that emits a laser beam R1, an optical path setting material 7, and a shield element 8.

The shield element 8 blocks a reflected laser beam (hereinafter, reflected light R2) that is entered. The optical path setting material 7 is set so that an optical path of the reflected light R2 is directed to the shield element 8.

The optical path of the laser beam from the laser element to an object (i.e. optical fiber) may be described as an incident optical path. The optical path where a part of the laser beam returns to the laser element after being reflected by the airtight sealing glass or the like may be described as a reflective optical path. The optical path setting material 7 reflects a part of the laser beam R1 so that the reflective optical path is directed to the shield element.

Under the above configuration, the reflective optical path is set so that when a part of the laser beam R1 from the laser element 4 is reflected by the optical path setting material 7, the reflected light R2 is directed to the shield element 8. Since the shield element 8 blocks the reflected light R2, the reflected light R2 does not enter any materials that affect output characteristics of the optical module (e.g. power, wavelength) of the laser beam R1 emitted from the laser element 4.

Further, when a plurality of optical paths of the reflected light that is set by the optical path setting material 7 are arranged, a plurality of shield materials may be used.

Any material is available for the shield element 8, if the material does not affect the output characteristics (e.g. power, the wavelength) of the laser beam emitted from the optical module 2A when the reflected light R2 enter the shield element 8. In the first exemplary embodiment, a base that supports the laser element 4 is exemplified as the shield element 8.

Moreover, a material of the shield element 8 is not only limited to materials that are already used for the optical module, but also a newly installed material for the purpose of blocking the reflected light R2.

As mentioned above, it is possible to prevent the reflected light from entering the material that affects output characteristics (e.g. power, wavelength) of the laser beam emitted from the optical module. Therefore, it is possible to provide the optical module having stable characteristics including output power of the laser beam.

### 2. Second Exemplary Embodiment

Next, a second exemplary embodiment of the present invention is described below. The second exemplary embodiment relates to detailed configuration of the optical module including the first exemplary embodiment. An element in the second exemplary embodiment which corresponds to the element of the first exemplary embodiment has the same reference numeral as that of the first exemplary embodiment, and descriptions on the element are skipped.

FIG. 2 is a longitudinal sectional view of the optical module according to the second exemplary embodiment. An optical module 28 includes a package 12 having a rectangular shape, an airtight sealing glass 16 (optical element). The package 12 includes a base element 8, the laser element 4, a monitoring element 6, and a collimator lens 18. Further, the base element 8 functions as the shield element.

The laser element 4 emits the laser beam R1 in the direction of the airtight sealing glass 16 and also emits the laser beam R3 in the direction of the monitoring element 6. The monitoring element 6 receives the laser beam R3 and outputs a monitoring signal corresponding to intensity of the received laser beam. The laser element 4 is controlled by the monitoring signal so as to output predetermined output power. The collimator lens 18 changes the laser beam R1 to a parallel beam. The monitoring element 6, the laser element 4, and the collimator lens 18 are arranged on the base element 8 toward the airtight sealing glass 16 in this order.

The airtight sealing glass 16 is fitted in an aperture 14 that is formed on a side wall of the package 12 to hermetically seal the package 12. The airtight sealing glass 16 is made of a disk-shaped transparent member having a constant thickness. The laser beam R1 from the laser element 4 passes through the airtight sealing glass 16. The airtight sealing glass 16 is inclined with respect to the laser beam R1 so that the base element 8 is positioned in the normal direction of an incidence surface 16a of the airtight sealing glass 16. Note that “inclined with respect to the laser beam R1” above described may mean that being inclined with respect to a plane perpendicular to the laser beam.

The incidence surface 16a and an output surface 16b in the airtight sealing glass 16 function as an optical path setting member. Followings are descriptions on a case where the incidence surface 16a of the airtight sealing glass 16 functions as the optical path setting member. However, almost the same descriptions are available for a case where the output surface 16b functions as the optical path setting member. Since a thickness of the airtight sealing glass 16 is almost constant, each of the incidence surface 16a and the output surface 16b may function as the optical path setting member.

The reason why the airtight sealing glass 16 is inclined is described below. A part of the laser beam R1 is reflected at the incidence surface 16a of the airtight sealing glass 16. When the reflected laser beam (i.e. reflected light R2) enters the laser element 4, the laser element 4 may suffer damages and the output characteristics thereof may become unstable. In addition, the monitoring signal outputted from the monitoring element 6 increases in proportion to intensity of the reflected light R2 that enters the monitoring element 6. As a result, output power of the laser element 4 becomes lower than predetermined output power.

Then, as mentioned above, the incidence surface 16a of the airtight sealing glass 16a is inclined so that the base element 8 is positioned in a normal direction of the incidence surface 16a of the airtight sealing glass 16. Accordingly, the laser beam R1 is reflected at the incidence surface 16a and the reflected light R2 proceeds toward the base element 8. Since the base element 8 functions as the shield element, the base element 8 blocks the reflected light R2. Therefore, the reflected light R2 does not enter the monitoring element 6 and the laser element 4 that affects the output characteristics (e.g. power, wavelength) of the laser beam emitted from the optical module.

If the airtight sealing glass 16 is inclined, an incident optical path and a reflective optical path are different from each other. Therefore, the reflected light R2 does not enter the laser element 4.

However, even when the incident optical path is different from the reflective optical path, the reflected light R2 may enter the monitoring element 6. FIG. 3 describes such a case. FIG. 3 is a lateral view of the optical module disclosed by Japanese Patent Application Laid-Open No. 1992-355705.

In FIG. 3, a normal direction of an incidence surface 210a of the airtight sealing glass 210 is a direction where a shield element is not positioned (upward direction in FIG. 3). Therefore, a reflected light R22 does not enter a laser element 204. However, a reflected light R22 may enter a collimator lens 216 again, may be refracted at the collimator lens 216 and may enters a monitoring element 214. In this case, the monitoring element 214 cannot correctly monitor output power of the laser element 204.

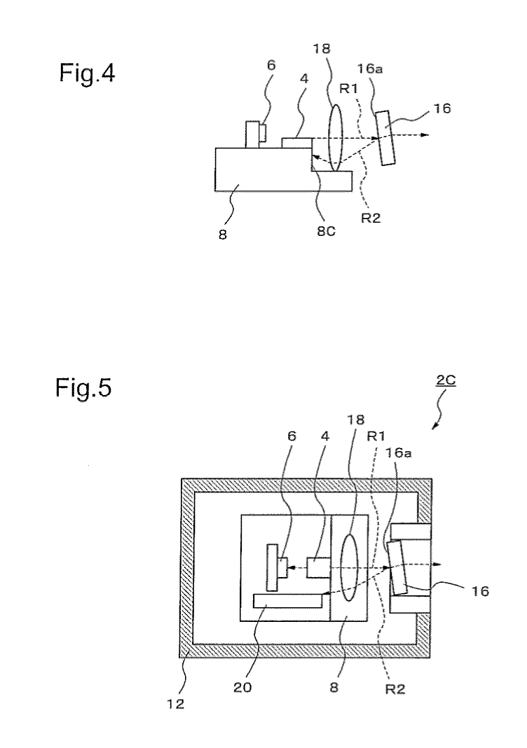

In the second exemplary embodiment, the incidence surface 16a is inclined as shown in FIG. 4 so that the reflected light R2, which is reflected at the incidence surface 16a of the airtight sealing glass 16, is directed to the base element 8. FIG. 4 is a typical lateral view of the optical module illustrating the optical path of the reflected light R2 from, the inclined, incidence surface 16a.

The reflected light R2 from the incidence surface 16a enters the collimator lens 18 and is refracted by the collimator lens 18, and is emitted. Since a side wall 8c of the base element 8 located on is an extension of the optical path of the reflected light R2 emitted from the collimator lens 18, the reflected light R2 is blocked by the side wall 8c of the base element 8. Accordingly, the reflected light R2 does not enter the monitoring element 6. In addition, since the optical path of the reflected light R2 is different from the optical path of the laser beam R1, the reflected light R2 does not enter the laser element 4.

As described above, the reflected light is blocked by the base element when the incidence surface 16a of the airtight sealing glass is inclined. Therefore, the reflected light enters neither the laser element nor the monitoring element. Accordingly, the laser element 4 does not suffer damages and the output characteristics do not become unstable. Further, since the output power of the laser element is monitored accurately, precise control of the output power of the laser element can be achieved. Therefore, the output characteristics of the laser element in the optical module become stable.

### 3. Third Exemplary Embodiment

Next, a third, exemplary embodiment of the present invention is described below. An element in the third exemplary embodiment which corresponds to the element of the second exemplary embodiment has the same reference numeral as that of the second exemplary embodiment, and descriptions on the element are skipped.

The second exemplary embodiment mentioned above described the base element as an example for the shield element. On the other hand, the shield element in the third exemplary embodiment uses a wiring board.

FIG. 5 shows a horizontal sectional view of the optical module 2C of the third exemplary embodiment. The optical module 2C includes the package 12, the airtight sealing glass 16, the base element 8, the laser element 4, the monitoring element 6, and the collimator lens 18. An optical module 2C has a wiring board 20 that is used as a signal terminal for the monitoring element 6 and the laser element 4. The wiring board 20 is mounted on the base element 8 adjacently with the laser element 4 and the monitoring element 6, and functions as a terminal for supplying electricity to the laser element 4 and the monitoring element 6. Further, according to the third exemplary embodiment, the incidence surface 16a is inclined so that the reflected light R2, which is reflected at the incidence surface 16a of the airtight sealing glass 16 that functions as the optical path setting material, enters the wiring board 20. That is, the incidence surface 16a is inclined so that the wiring board 20 is located in the normal direction of the incidence surface 16a. Accordingly, the reflected light R2 is blocked by the wiring board 20.

Since the incidence surface of the airtight sealing glass is inclined and the reflected light is blocked by the wiring board, the reflected light enters neither the laser element nor the monitoring element. Accordingly, the laser element 4 does not suffer damages and the output characteristics do not become unstable. Further, since the output power of the laser element is monitored accurately, precise control of the output power of the laser element can be achieved. Therefore, the output characteristics of the laser element in the optical module become stable.

### 4. Fourth Exemplary Embodiment

Next, fourth exemplary embodiment of the present invention is described below. An element in the fourth exemplary embodiment which corresponds to the element of the second exemplary embodiment has the same reference numeral as that of the second exemplary embodiment, and descriptions on the element are skipped.

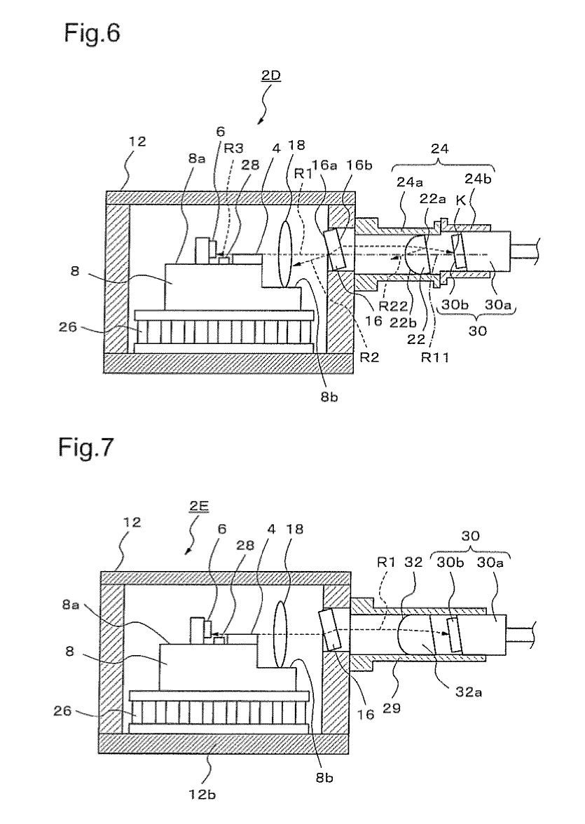

FIG. 6 is a longitudinal sectional view of the optical module 2D having the second sleeve 24b which includes an optical fiber 30 with an optical isolator being arranged on an end face of an optical fiber 30a. The optical module 2D includes the package 12, the airtight sealing glass 16, the base element 8, the laser element 4, the monitoring element 6, and the collimator lens 18. Also, the optical module 2D includes a condenser lens 22 (optical element) and a sleeve 24.

In FIG. 6, in addition to the above-mentioned components, a cooling element 26 such as a Peltier element and a thermal detector 28 such as a platinum thermocouple (e.g. platinum/platinum-rhodium(13%)) are included. To include the cooling element 26 and the thermal detector 28 does not limit the fourth exemplary embodiment.

The cooling element 26 is arranged between the package 12 and the base element 8. The laser element 4, the monitoring element 6, the collimator lens 18, and the thermal detector 28 are mounted on the base element 8. The collimator lens 18, the laser element 4, and the monitoring element 8 are arranged on the base element 8 next to the airtight sealing glass 16 in this order.

The sleeve 24 includes a first sleeve 24a and a second sleeve 24b. The condenser lens 22 is installed in the first sleeve 24a, The second sleeve 24b includes a receptacle and an optical fiber inserted in a ferrule.

The optical isolator 30b puts an incident laser beam R1 therethrough directionally. The optical isolator 30b includes a configuration in which a single optical crystal is sandwiched between two polarizers. Although optical isolators with various configurations are known, the fourth exemplary embodiment is not limit by the configurations of the optical isolators. However, the optical isolator needs to put the incident laser beam R1 therethrough directionally.

Even if the laser beam R1 reflects at the end face of the optical fiber 30a, such an optical isolator 30b blocks the reflected light so that the reflected light does not return to the laser elements 4. Accordingly, the laser beam, which is reflected at the end face of the optical fiber 30a, enters neither the laser element 4 nor the monitoring element 6.

When the optical isolator 30b and the optical fiber 30a are installed separately, the optical module becomes large due to a space therebetween. However, in the fourth exemplary embodiment, the space can be reduced or removed by using the optical fiber with the optical isolator 30. Therefore, the optical module can be reduced.

The airtight sealing glass 16 is made of a disk-shaped transparent member having a constant thickness. The airtight sealing glass 16 is fixed to the package 12 using solder or the like to seal the package 12 hermetically. The laser beam R1 from the laser element 4 passes through the airtight sealing glass 16. As described in the second exemplary embodiment, the incidence surface 16a of the airtight sealing glass 16 is inclined so that the reflected light R2 enters the base element 8 that functions as the shield element.

The thermal detector 28 is arranged on the base element 8 or is embedded in the base element 8. The thermal detector 28 detects a temperature of the laser element 4, and the cooling element 26 adjusts the temperature of the laser element 4 according to the detected result. Further, the thermal detector 28 detects the temperature of the base element 8, and the cooling element 26 adjusts the temperature of the base element 8. However, since heat capacity of the base element 8 is larger than that of the laser element 4, the temperature of the base element 8 is almost the same as the temperature of the laser element 4.

The base element 8 is fixed, to the cooling element 26 using solder or the like. Further, the laser element 4, the monitoring element 6, a element mounting part 8a which the thermal detector 28 is mounted on, and the lens mounting part 8b which the collimator lens 18 is mounted on, are arranged on the base element 8.

The laser element 4 is fixed to the element mounting part 8a by using gold-tin solder, for example. The laser element 4 emits the laser beam R1 in a direction of the airtight sealing glass 16 and also emits the laser beam R3 in a direction of the monitoring element 6.

The collimator lens 18 changes the laser beam R1 from the laser element 4 into a parallel light. The condenser lens 22 having the incidence surface with a spherical surface or a non-spherical surface focuses the laser beam R1 to optically align the laser beam R1 with the optical fiber with high efficiency.

In FIG. 6, an output surface 22a of the condenser lens 22 forms a flat surface. However, it is possible that an incidence surface 22b is fiat and the output surface 22a is either spherical or non-spherical. In the fourth exemplary embodiment, a case where the output surface 22a of the condenser lens 22 is flat is described.

The output surface 22a of the condenser lens 22 is inclined with respect to the center axis of the first sleeve 24a. The normal direction of the inclined surface is coincident with the normal direction of the output surface 22a on the inner side of the condenser lens 22. The shield element exists in the direction. That is, the output surface 22a is inclined so that the laser beam R22 which is reflected at the output surface 22a of the condenser lens 22 is directed to the shield element. In the fourth exemplary embodiment, since the base element 8 serves as a shield element and is positioned, on the lower side of the laser beam R1 in FIG. 6, the output surface 22a is inclined downwardly. Further, the output surface 22a of the condenser lens 22 and the incidence surface 16a of the airtight sealing glass 16 are served as optical path setting elements.

The laser beam R1, that is refracted by the condenser lens 22 and then emitted from the output surface 22a, focuses at a misaligned, position with respect to an extended line R11 of the laser beam R1 since the output surface 22a is inclined. Hereinafter, an optically focused point denotes a point where the laser beams R1 focuses. Accordingly, the optical focused point K shifts upwardly with respect to the extended line R11 in FIG. 6.

A core of the optical fiber 30a is arranged so as to coincide with a center axis of the second sleeve 24b. Since the center axes of both the first sleeve 24a and the second sleeve 24b are arranged on the same line, the optically focused point K of the laser beam R1 deviates from a core position of the optical fiber 30a. Accordingly, the laser beam R1 cannot be optically coupled with the optical fiber with high efficiency.

Therefore, a position of the second sleeve 24b to the first sleeve 24a is adjusted so that the optically focused point K of the laser beam R1 is positioned on the center axis of the second sleeve 24b. That is, the second, sleeve 24b is shifted, so that a core position of the optical fiber 30a coincides with the position of the optically focused point K. In FIG. 6, the position of the second sleeve 24b is adjusted in the direction vertical to the center axis of the second sleeve 24b, and is specifically adjusted in an upward direction in FIG. 6. Accordingly, the laser beam R1 forms the optically focused point K at the core position, and is optically coupled with the optical fiber with high efficiency.

In the aforementioned configuration, the laser element 4 emits the laser beam R1 in the direction of the collimator lens 18 and also emits the laser beam R3 in the direction of the monitoring element 6.

The laser beam R1 is changed into a parallel beam by the collimator lens 18. After that, the parallel beam passes through the airtight sealing glass 16 and enters the condenser lens 22. Further, the condenser lens 22 focuses the laser beam R1 at the core position of the optical fiber 30a.

In addition, the laser beam R3 enters the monitoring element 6. The monitoring signal corresponding to the intensity of the laser beam R3 is outputted from the monitoring element 6, and the output power of the laser element 4 is adjusted according to the monitoring signal.

Further, the thermal detector 28 detects a temperature of the laser element 4 and outputs the result of the detection to the cooling element 26 as a temperature signal. The cooling element 26 cools or heats the base element 8 according to the temperature signal, so that the temperature of the laser element 4 falls within a predetermined range. By cooling or heating the base element 8, the temperature of tire laser element 4 is adjusted.

Due to a long operation of the optical module, the temperature of the laser element 4 may fluctuates, and the output power of the laser element 4 may fluctuates accordingly. However, as is mentioned above, since the cooling element 26 adjusts the temperature of the laser element 4, fluctuation of the output power of the laser element 4 is suppressed.

Under the described configuration, following is descriptions on behavior of the reflected light R22 from the output surface 22a of the condenser lens 22. Since the output surface 22a is inclined to the base element (i.e. shield element), the optical path of the reflected light R22 is different from that of the incident light R1.

When passing through the airtight sealing glass 16, the reflected light R22 is refracted. In this case, since the thickness of the airtight sealing glass 16 is almost constant, although an optical path of the reflected light R22 which enters the output surface 16b of the airtight sealing glass 16 does not coincide with the optical path of the reflected light R22 that is emitted from the incidence surface 16a of the airtight sealing glass 16, both paths take the same direction. Accordingly, the optical path of the reflected light R22, that is reflected at the output surface 22a of the condenser lens 22 and returns to the package 12, is directed to the base element 8. Therefore, the reflected light R22 enters neither the laser element 4 nor the monitoring element 6.

As described above, since the output surface of the condenser lens and the incidence surface of the airtight sealing glass are inclined so that reflected lights from the surfaces are blocked by the base element, the reflected lights enter neither the laser element nor the monitoring element. Accordingly, the laser element 4 does not suffer damages and output characteristics thereof do not become unstable. Further, since the output power of the laser element is monitored accurately, precise adjustment of the output power of the laser element is achieved. Therefore, the output characteristics of the laser element of the optical module become stable.

### 5. Fifth Exemplary Embodiment

Next, a fifth exemplary embodiment of the present invention is described below. An element in the fifth exemplary embodiment which corresponds to the element of the fourth exemplary embodiment has the same reference numeral as that of the fourth exemplary embodiment, and descriptions on the element are skipped.

FIG. 7 is a longitudinal sectional view of an optical module 2E of the fifth exemplary embodiment. The optical module 2E includes the package 12, the airtight sealing glass 16, the base element 8, the laser element 4, the monitoring element 6, and the collimator lens 18. The optical module 2E includes a condenser lens 32 and a sleeve 29. Further, the optical module 2E may include the cooling element 26 and the thermal detector. In the following description, the optical module 2E including all the elements above mentioned are exemplified.

The flat surface of the condenser lens in the optical module in the fourth exemplary embodiment is inclined. Also, the sleeves are divided into a first sleeve having the condenser lens and a second sleeve having the optical fiber in the fourth exemplary embodiment. The position of the second sleeve to the first sleeve is adjusted so that the optically focused point of the laser beam focused by the condenser lens is positioned at the core of the optical fiber in the fourth exemplary embodiment.

In contrast, in the fifth exemplary embodiment, the single sleeve 29 houses the condenser lens 32 and the optical fiber 30a and aligns the optical axis of the condenser lens 32 and the center axis of the optical fiber 30a with the center axis of the sleeve 29, as shown in FIG. 7. Further, when the position of the optically focused point of the laser beam R1 focused by the condenser lens 32 is adjusted, the optically focused point is positioned on the center axis of the sleeve 29. Adjustment of the optically focused point can be conducted by changing the position of the laser element to the optical axis of the condenser lens 32.

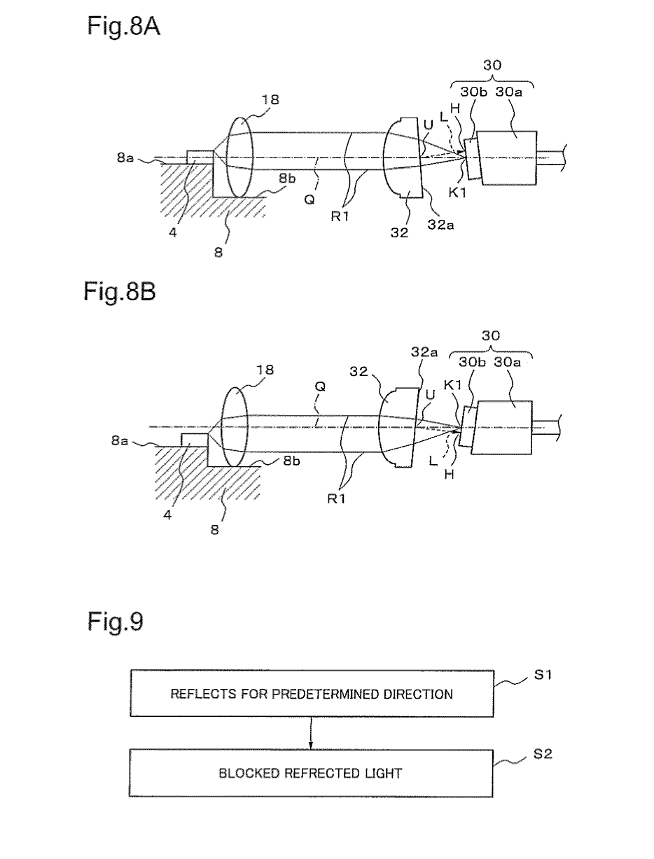

The adjustment is described with reference to FIGS. 8A and 8B. A line including the optical axes of the collimator lens 18 and the condenser lens 32, and the center axis of the optical fiber 30a is describes as an optical system axis Q below. As shown in FIG. 7, the optical system axis Q is also coincident with the center of the sleeve 29. Although the laser beam R1 is emitted from an active layer of the laser element 4, a position of the laser element 4 in the specification includes the position of the active layer.

FIG. 8A is a fragmentary longitudinal cross-sectional view of the optical module in which the output surface 32a of the condenser lens 32 is inclined in the counterclockwise direction with respect to a face vertical to the optical system axis Q. In this case, the optically focused point K1 of the laser beam R1 focused by the condenser lens 32 shifts below the position of the active layer of the laser element 4. Accordingly, in FIG. 8A, since the position of the laser element 4 is shifted above the optical system axis Q, the optically focused point K1 is positioned on the optical system axis Q.

On the other hand, FIG. 8B illustrates a configuration in which the output surface 32a of the condenser lens 32 is inclined in the clockwise direction with respect to a face vertical to the optical system axis Q. In this case, the optically focused point K1 is shifted above the position of the active layer of the laser element 4. Accordingly, in FIG. 8B, since the position of the laser element 4 is shifted below the optical system axis Q, the optically focused point K1 is positioned on the optical system axis Q.

The descriptions above may be summarised as follows. Suppose that a point on a normal line H is an arbitrary point on an outer normal line L of the output surface 32a, and a starting point of the normal line L is a point U at the intersection of the output surface 32a with the optical system axis Q. Further, a reference point is a point of the intersection of the optical system axis Q with a line which passes through a point H on the normal line and which is vertical to the optical system axis Q. Then, the laser element 4 is shifted in the direction from the reference point to the point H on the normal line.

The base element 8 includes a lens mounting part 8b on which the collimator lens 18 is mounted. As shown in FIG. 7, FIGS. 8A, and 8B, the lens mounting part 8b is placed at a lower position than an element mounting part 8a on which the laser element 4 and the monitoring element 6 are mounted. According to the fifth exemplary embodiment, when a difference in level between the element mounting part 8a and the lens mounting part 8b is adjusted, a position of the optically focused point K1 is adjusted so as to lie on the optical system axis Q.

Specifically, a height of the lens mounting part 8b is adjusted so that the optical system axis Q coincides with a center axis of the collimator lens 18. Further, as shown in FIG. 7, the height is measured from a bottom plate 12b of the package 12.

Next, the height of the element mounting part 8a from the lens mounting part 8b, that is, the difference in level is arranged so that the optically focused point K1 lies on the optical system axis Q. As a result, the height of the laser element 4 is adjusted.

Accordingly, since the laser beam focuses at the core position, the laser beam is optically coupled with the optical fiber with high efficiency. In addition, since the sleeve can hold both the condenser lens and the optical fiber, the number of parts and human-power for assembly can be reduced compared with the case where the sleeve is divided.

As described above, since the output surface of the condenser lens and the incidence surface of the airtight sealing glass are inclined so that the base element blocks the reflected lights from the surfaces, the reflected light enters neither the laser element nor the monitoring element. Accordingly, the laser element 4 does not suffer damages and the output characteristics thereof do not become unstable. Further, since the output power of the laser element is monitored accurately, precise control of the output power of the laser element can be achieved. Therefore, the output characteristics of the laser element used for the optical module become stable.

Moreover, since the laser beam focuses at the core position, the laser beam is optically coupled with the optical fiber with high efficiency. In addition, since the sleeve can hold both the condenser lens and the optical fiber, the number of parts and human-power for assembly can be reduced compared with the case where the sleeve is divided. Therefore, a low-cost optical module can be provided.

### 6. Sixth Exemplary Embodiment

Next, a sixth exemplary embodiment of the present invention is described below. The sixth exemplary embodiment relates to a reflective optical path setting method where an optical path of a reflected light is set when a laser beam emitted from a laser element is reflected.

FIG. 9 is a flowchart showing procedures of the reflective optical path setting method according to the sixth exemplary embodiment. The reflective optical path setting method includes a reflective procedure SI and a shield procedure S2.

The reflective procedure S1 is a procedure in which the optical path of the laser beam reflected by an optical path setting material and the like is directed in a predetermined direction. The shield procedure S2 is a procedure in which the entered reflected light is blocked.

By following the procedures, the optical path of the reflected light is set to an incident direction toward the shield element, even if the laser beam is reflected by the airtight sealing glass, the condenser lens, or the like. Accordingly, the reflected light does not enter members that affect the output characteristics, for example, power of the laser beam emitted from the laser element, or wavelength.

Further, in the sixth exemplary embodiment, in the reflective procedure S1 may include a procedure of transmitting the laser beam such as an airtight sealing glass, the condenser lens, and the like, and procedure of focusing the laser beam.

As describe above, since the optical path of the reflected light is set and the reflected light is blocked with simple procedure and less man-hour, the reflected light is prevented from entering into the laser element and the monitoring element can be blocked with low-cost. Accordingly, the laser element 4 does not suffer damages and the output characteristics do not become unstable. Further, since the output power of the laser element is monitored accurately, precise control of the output power of the laser element can be achieved. Therefore, the output characteristics of the laser element of the optical module become stable.

### 7. Seventh Exemplary Embodiment

Next, a seventh exemplary embodiment of the present invention is described below. An element in the fifth exemplary embodiment which corresponds to the element of the above exemplary embodiments has the same reference numeral as that of the exemplary embodiments, and descriptions on the element are skipped. The seventh exemplary embodiment relates to an optical communication device using one of the optical modules in the above exemplary embodiments. In following descriptions, the optical communication device using the optical module of the fifth exemplary embodiment is exemplified.

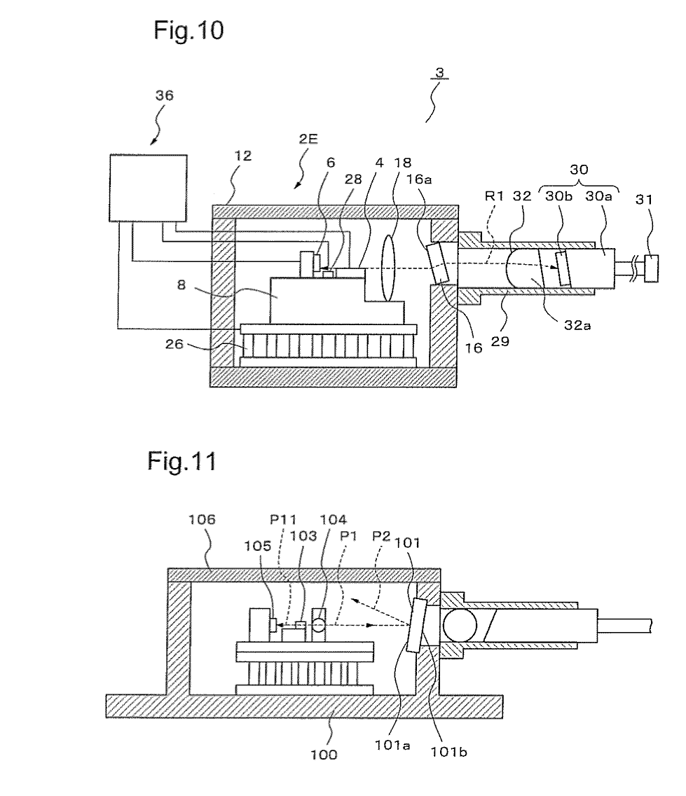

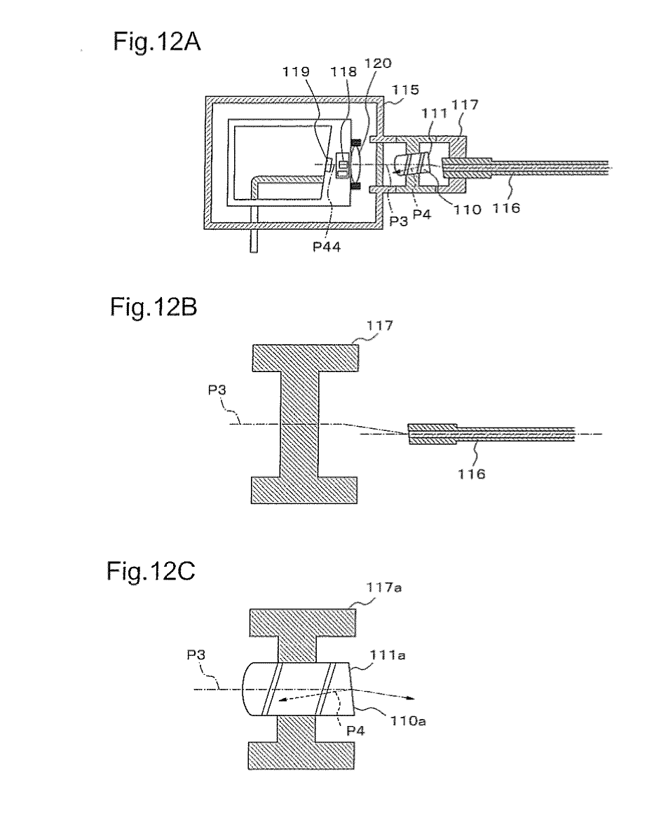

FIG. 10 is a fragmentary sectional view of the optical communication device in the seventh exemplary embodiment. An optical communication device 3 includes an optical module 2E, an optical fiber 30a connected to the optical module 2E, and a control-drive circuit 36 for driving the optical module 2E. An optical communication unit 31 is provided at the other end of the optical fiber 30a.

The laser element 4, the monitoring element 6, the thermal detector 28, and the cooling element 26 are electrically connected to the control-drive circuit 36. In FIG. 10, the laser element 4, the monitoring element 6, the thermal detector 28, and the cooling element 26 may be connected with the control-drive circuit 36 through a wiring board, a connection terminal, or the like.

A predetermined driving data, such as a preset value of the output power of the laser element 4, a preset temperature of the laser element 4, and a signal data for the optical communication, are set in the control-drive circuit 36, and the control-drive circuit 36 drives the laser element 4 according to the driving data. Further, it is supposed that the preset value of the output power of the laser element 4 and the preset temperature of the laser element 4 are determined in advance.

The laser beam R1 is emitted from the laser element 4 by driving the laser element 4. The laser beam R1 is changed into a parallel light by the collimator lens 18, then passes through the airtight sealing glass, and is focused by the condenser lens 32. The focused laser bears R1 enters the optical fiber 30a. Since the incidence surface 16a of the airtight sealing glass 16 and the output surface 32a of the condenser lens 32 are inclined in the direction of the base element 8 that functions as the shield element, the reflected light from the incidence surface 16a and the output surface 32a enter neither the laser element 4 nor the monitoring element 6. Accordingly, the monitoring element 6 can precisely monitor the current output power of the laser element 4.

When a monitoring signal from the monitoring element 6 enters the control-drive circuit 36, the control-drive circuit 36 compares a value of the entered monitoring signal with the preset output power value for the element 4 and then adjusts the output power of the laser element 4. For example, when the value of the monitoring signal is larger than the preset value of the output power, the control-drive circuit 36 drives the laser element 4 so that the difference between the values decreases. As the result, the output power of the laser element 4 is adjusted to the preset value of the output power.

On the other hand, a temperature of the laser element 4 is detected by the thermal detector 28, and the detected result enters the control-drive circuit 36 as a temperature signal. The control-drive circuit 36 compares a current temperature based on the entered temperature signal with the preset temperature and then drives the cooling element 26 according to the compared result. For example, when the temperature corresponding to the inputted temperature signal is larger than the preset temperature, the control-drive circuit 36 drives the cooling element 26 so that the temperature of the laser element 4 decreases. As a result, the temperature of the laser element 4 is kept within a prefixed range, and output power fluctuation of the laser element 4 due to temperature fluctuation can be suppressed.

As described above, since the output characteristics of the optical module become stable, the optical communication device can conducts the high-quality optical communication.

While the invention has been particularly shown and described with reference to exemplary embodiments thereof, the invention is not limited to these exemplary embodiments. It will be understood by those of ordinary skill in the art that various changes in form and details may be made therein without departing from the spirit and scope of the present invention as defined by the claims. Further, it is the inventor's intention to retain all equivalents of the claimed invention even if the claims are amended during prosecution. What is claimed is:

1. An optical module including a laser element which emits a laser beam, comprising:
an optical path setting material which reflects a part of said laser beam in a predetermined direction; and
a shield element which blocks said laser beam that is reflected by said optical path setting material.

2. The optical module according to claim 1, further comprising:
an optical element which transmits said laser beam, wherein
said optical path setting material includes said optical element, and at least one of an incidence surface and an output surface of said optical element is inclined in a predetermined direction.

3. The optical module according to claim 2, wherein
said, optical element includes an airtight sealing glass which hermetically seals a package having at least said laser element and said shield element.

4. The optical module according to claim 2, wherein
said optical element includes a lens which refracts said laser beam.

5. The optical module according to claim 4, wherein
said lens includes a condenser lens which focuses said laser beam.

6. The optical module according to claim 5, wherein
a position of said laser element is adjusted with respect to an optical axis of said lens so that an optically focused point of said laser beam which is refracted and focused by said lens lies at a predetermined position.

7. The optical module according to claim 6, wherein
when a normal line point denotes a point on a normal line which passes through an intersection of a surface of said lens with said optical axis of said lens and which is directed to an outside of said lens, and when a reference point denotes an intersection of said optical axis with a line which passes through said normal line point and which is vertical to said optical axis, said laser element is positioned in a direction from said reference point toward said normal line point.

8. The optical module according to claim 1, further comprising:
a monitoring element which is positioned on an extension of a reflective optical path blocked by said shield element, and which monitors power of said laser beam from said laser element.

9. The optical module according to claim 1, further comprising:
a collimator lens which change said laser beam from said laser element into a parallel light, wherein
said shield element blocks said reflected light which passes through said collimator lens.

10. The optical module according to claim 1, further comprising:
a base element which supports said laser element and serves as said shield element.

11. The optical module according to claim 1, further comprising:
a wiring board which is used at least for supplying electric power to said laser element and also serves as said shield element.

12. An optical module including a laser beam emitting means which emits a laser beam, comprising:
an optical path setting means for reflecting a part of said laser beam in a predetermined direction; and
a shield means for blocking said laser beam reflected by said optical path setting means.

13. The optical module according to claim 12, further comprising:
an optical means for transmitting said laser beam, wherein
said optical path setting means includes said optical means, and at least one of an incidence surface and an output surface of said optical means is inclined in a predetermined direction.

14. The optical module according to claim 12, further comprising;
a monitoring means which is positioned on an extension of a reflective optical path blocked by said shield means, and which monitors power of said, laser beam from said laser beam emitting means.

15. An optical communication device comprising:
a laser element which emits a laser beam;
an optical path setting material which reflects a part of said laser beam in a predetermined, direction;
an optical module including a shield element which blocks said laser beam reflected from said optical path setting material;
a driving circuit which drives said optical, module; and
an optical fiber which said laser beam from said optical module enters.

16. A reflective optical path setting method, comprising:
reflecting a part of a laser beam emitted from a laser element in a predetermined direction; and
blocking said laser beam reflected by said reflective procedure.

17. The reflective optical path setting method according to claim 16, wherein said reflecting includes at least one of transmitting said laser beam and focusing said laser beam.
